(19) United States
(12) Patent Application Publication
(10) Pub. No.: US 2023/0252539 A1
(43) Pub. Date: Aug. 10, 2023

(54) METHOD AND SYSTEM FOR SELLING AND/OR TRACKING PRODUCTS AT BRICK-AND-MORTAR BOUTIQUES OR RESELLERS

(71) Applicant: Charles SHAKER, London (GB)

(72) Inventor: Charles SHAKER, London (GB)

(21) Appl. No.: 18/004,625

(22) PCT Filed: Jul. 7, 2021
(86) PCT No.: PCT/CA2021/050929

§ 371 Date: Jan. 6, 2023

Related U.S. Application Data
(60) Provisional application No. 63/048,786, filed on Jul. 7, 2020.

(51) Int. Cl. G06Q 30/0601; G06Q 10/083; G06Q 10/087; G06Q 30/0202

(52) U.S. Cl. CPC G06Q 30/0603; G06Q 10/083; G06Q 10/087; G06Q 30/0202; G06Q 30/0639; G06Q 30/0641

(57) ABSTRACT

There is provided methods and systems for expanding the available inventory for sale by independent brick-and-mortar boutique/resellers by virtually pooling the inventory of a plurality of independent brick-and- mortar boutique/resellers and optionally product suppliers including brands. There is also provided methods and system for tracking products through their lifecycle and use of information to facilitate product manufacture and purchasing decisions.

### FIELD OF THE INVENTION

This invention pertains generally to retail shopping and, more particularly to a method and system for selling and/or tracking products at brick-and-mortar boutiques or independent resellers.

### BACKGROUND OF THE INVENTION

Boutiques or independent resellers (“Boutiques/Resellers”) offer a distinct, curated shopping experience compared to box stores, retail chain stores and department stores. Boutiques and independent resellers generally have a more limited focus, often specializing in specific consumer products and/or brands. The inventory size and scope of a boutique or independent reseller is more limited than larger retailers. Boutiques and independent resellers appeal to shoppers looking for both a more personalized shopping experience and expert assistance. Customers shopping on-line cannot see, touch or try on clothes, resulting in a less desirable shopping experience and more returns and exchanges. Sales at brick-and-mortar (i.e., physical location) boutiques and independent resellers are facilitated by expert sales staff well informed in both the products they sell and the clienteles’ likes and dislikes. As a result, boutiques and independent resellers often have a loyal customer base that can translate into a successful retail business both in-store and on-line and less product returns.

A portion of on-line returns are a result of customers returning products that they have used once or twice. As boutiques and independent resellers have the option of inspecting returns, some of the challenges relating to the returns can be avoided.

Traditional boutiques and independent resellers, in part because of a more limited inventory, face unique challenges in the retail space including e-retail space. A key aspect of retail success both in-store and on-line is the availability of desired product.

There exists a need in the art to expand the available inventory of boutiques while maintaining boutique specific customer bases.

Clothing manufacturers and brands (“Manufactures/Brands”) also face unique challenges when providing product to traditional boutiques and independent resellers. Manufactures/Brands generally engage boutiques and independent resellers by wholesale distribution of its merchandise. As a result, Manufactures/Brands have little, if any, visibility on the merchandise’s lifespan post-wholesale including product movement information (e.g., date of purchase by Customer, returns, etc.) and/or adjustments to manufacture’s retail price down from suggested retail price (SRP) (including sales discounts, mark-downs). Direct consumer feedback and product satisfaction data available to the Manufactures/Brands is thus limited.

Traditional boutiques and independent resellers set the price of a product according to customer demand and how long the product took to sell (sales discounts, mark-downs). A specific product may be sold for less than the suggested retail price (SRP) to move the product, failure of a specific product to sell may be due to poor curation/merchandising by the Brand and Boutique/Reseller. The Boutique/Reseller usually suffers the loss in profit margin as it is preferrable to move the product than have it sit unsold for extended periods of time. The longer a product remains unsold, the greater the risk of product damage, theft or obsolescence.

The process for receiving orders from traditional boutiques and independent resellers is fragmented and inefficient, creating more costs and delays, double data entry requirements and allows only for Just-In-Case (JIC) product purchasing, rather than Just-In-Time (JIT) purchasing. JIT purchasing not only reduces the risk to traditional boutique and independent reseller, it can increase the appetite for purchase (for example: a Reseller could use its working capital on promoting its business/products through marketing and hiring sales staff, rather than using it for JIC inventory purchasing, which could result in 1) purchasing less-than-optimal product (i.e., product that doesn’t sell at the intended retail price within the intended time period) and 2) a depreciable asset through loss, damage, theft or obsolescence due to unnecessary warehousing. Lack of information can result in an unwillingness of Boutiques/Resellers to embrace new product lines.

The Brand and the Boutique/Resellers have limited options for optimizing the geo-economical distribution of merchandise, because the product life data (including, but not limited to wholesale and retail pricing, final sale pricing, point-of-sale, customer location, product destination, returns data, exchange data) are not centrally captured and analysed.

As product movement data, direct consumer feedback and product satisfaction data can be used to inform product manufacturing and product line decisions as well as stocking decisions at Boutiques/Resellers, there exists a need in the art to capture this information and make it available to both Manufactures/Brands and Boutiques/Resellers.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a method and system for selling and/or tracking products at brick-and-mortar boutiques or resellers.

In accordance with an aspect of the invention, there is provided a computer implemented method of tracking a product available at a plurality of brick-and-mortar boutiques or resellers through the product’s life cycle, the method comprising storing, in a database, inventory data from a plurality of independent brick-and-mortar boutiques/resellers, wherein the inventory data includes a plurality of product descriptions for products available for sale from the physical inventory of each boutique/reseller in the plurality of brick-and-mortar boutiques/resellers, wherein each product description is tagged with metadata describing the product, physical brick- and-mortar boutique/reseller location of the product and geographical location; and updating the inventory data is automatically updated when there is a change in the physical inventory of a boutique/reseller in the plurality of brick-and-mortar boutiques/resellers. In some embodiments, the inventory data is updated to include location of consumption or use of product.

In accordance with another aspect of the invention, there is provided a computer implemented inventory management system comprising an inventory management module configured to receive inventory data from a plurality of brick-and-mortar boutique/resellers, said inventory management module comprising at least one inventory database detailing the physical inventories of the brick-and-mortar boutique/resellers; a store management module configured to receive store information, said store management module comprising at least one store database; an inventory management application module configured to track inventory; one or more processors; and memory storing one or more programs to be executed by the one or more processors, the one or more programs comprising instructions for: receiving sales and/or product return information from one or more brick-and-mortar boutique/resellers; and updating the inventory database.

In accordance with an aspect of the present invention, there is provided an on-line method of selling a product available at a brick-and-mortar boutique/reseller, the method comprising: storing, in a database, inventory data from a plurality of independent brick-and-mortar boutique/resellers, wherein the inventory data includes a plurality of product descriptions for products available for sale from the physical inventory of each boutique/reseller in the plurality of brick-and-mortar boutique/resellers, wherein each product description is tagged with metadata describing the product, physical brick-and-mortar boutique/reseller location of the product and geographical location; and wherein the plurality of brick-and-mortar boutique/resellers comprises a consumer’s home brick-and-mortar boutique/reseller and a plurality of other brick-and-mortar boutique/resellers; providing an independent, on-line store front for each boutique/reseller in the plurality of brick-and-mortar boutiques/resellers; wherein each on-line store front provides a consumer interface for selecting a product for purchase from the plurality of product descriptions and wherein the on-line store front presented to a consumer is the on-line store front of the consumer’s home brick-and-mortar boutique/reseller; locating product selected by the consumer by searching the database for the product in the physical inventory of the home brick-and-mortar boutique/reseller, if the product is not available in the physical inventory of the home brick-and-mortar boutique/reseller, locating the product in the physical inventory of a other brick-and-mortar boutique/reseller; transferring the product, if available, from the other brick-and-mortar boutique/reseller to the home brick-and-mortar boutique/reseller; and completing the sale of the product to the consumer. In some embodiments, if the product is not available from another brick-and-mortar boutique/reseller, the brand or manufacturer of the product provides the product.

In accordance with another aspect of the invention there is provided a computer implemented inventory management system comprising: an inventory management module configured to receive inventory data from a plurality of brick-and-mortar boutique/resellers, said inventory management module comprising at least one inventory database detailing the physical inventories of the brick-and-mortar boutique/resellers; a store management module configured to receive store information, said store management module comprising at least one store database; an inventory management application module configured to facilitate transfer of inventory from one brick-and-mortar boutique/reseller to another brick-and-mortar boutique/reseller; one or more processors; and memory storing one or more programs to be executed by the one or more processors, the one or more programs comprising instructions for: searching at least one inventory database for a selected product; identifying at least one physical inventory containing the product; determining if the product needs to be transferred to a different physical inventory; and initiating the transfer the product, if necessary.

### BRIEF DESCRIPTION OF OF THE DRAWINGS

These and other features of the invention will become more apparent in the following detailed description in which reference is made to the appended drawings.

FIG. 1A is an illustration of the sales of merchandise from Manufacturer/ Brand to Boutique / Reseller to consumer. FIG. 1B is an illustration of possible paths of merchandise from a Manufacturer/ Brand to a consumer via one or two Boutiques or Resellers.

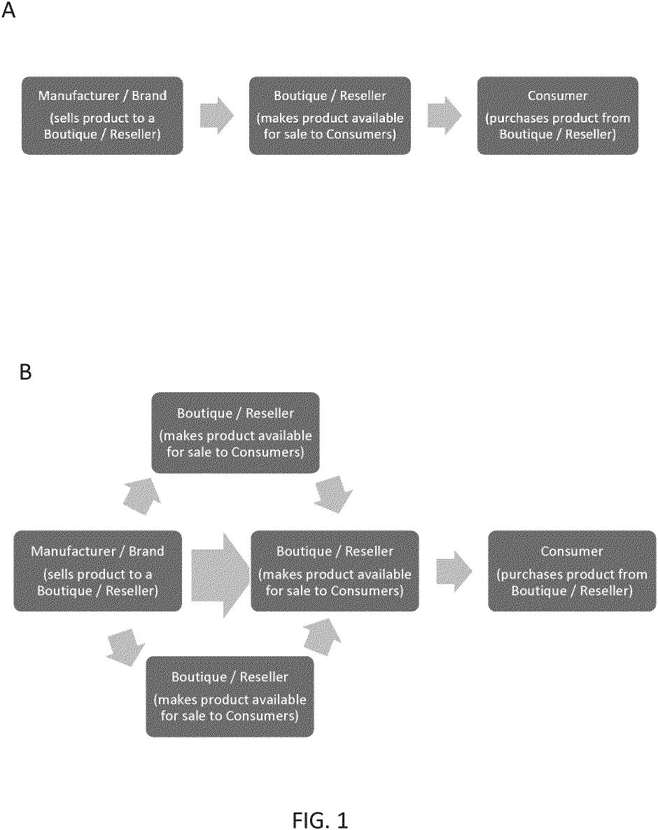

FIG. 2 is an illustration of relationship between an individual Manufacturer / Brand and multiple boutiques / independent resellers.

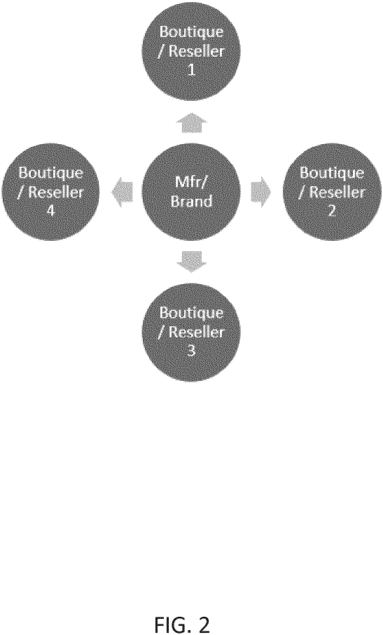

FIG. 3 is an illustration of a potential lifecycle of a product.

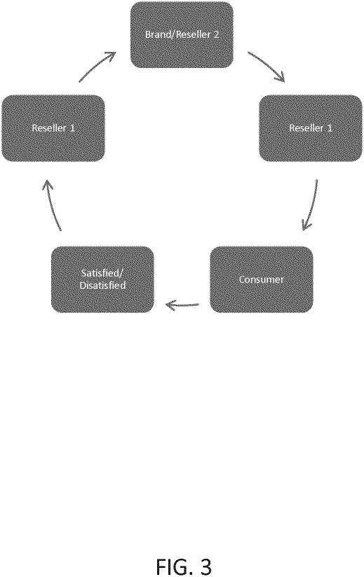

FIG. 4 is an illustration of how products are displayed on the home stores on-line store front.

FIG. 5 is a flow chart representative of the tiered inventory analysis in accordance with one embodiment of the invention.

FIG. 6 is a flow chart representative of the first tier of the tiered inventory analysis in accordance with one embodiment of the invention.

FIG. 7 is a flow chart representative of the second tier of the tiered inventory analysis in accordance with one embodiment of the invention.

FIG. 8 is a flow chart representative of the second tier of the tiered inventory analysis in accordance with alternative embodiment of the invention.

### DETAILED DESCRIPTION OF THE INVENTION

Embodiments of the invention provide methods and systems for expanding the available inventory for sale by independent brick-and-mortar boutiques and resellers (also called stores) by virtually pooling the inventory of a plurality of independent brick-and-mortar boutique/resellers and optionally product suppliers including manufacturers and brands.

The invention further provides methods and systems that creates a one-to-many relationship between a Manufacturer / Brand and the aggregate base of boutiques and independent resellers, allowing for streamlining of a Manufacturer’s or Brand’s wholesale distribution not only through conventional methods (individual orders placed through the Brand’s website, through emails, via showrooms and independent distributors) but also to become a Reseller itself and enjoy the higher profit margins. In some embodiments, the Brands do not sell directly to Consumers.

Independent brick-and-mortar boutiques or resellers include stores or retail businesses with a single physical location or small number of locations, for example two or three, often owned by an individual, a family or a partnership. Independent brick-and-mortar boutique/resellers of the invention include but are not limited to stores selling any consumer goods, including building materials, jewelry, fashion accessories, electronics, computer equipment, clothing, sporting equipment such as bicycles and skis, wine and spirits, audio equipment, luggage including handbags, shoes and horse tack including but not to limited to saddles and saddle accessories, and specialty boutiques including for example baby supplies including strollers and cribs and specialty food stores. The methods and systems of the invention are also applicable to the sale of vintage items including clothing, handbags, and shoes; antiques and classic or high end used cars, vinyl records and collectibles including trading cards and comic books. Optionally, products sold at these independent brick-and-mortar boutique/resellers are high value and/or luxury items and may have high re-sale value. These stores generally specialize in a limited number of brands.

The methods and systems of the invention are configured to track product by a product stock- keeping unit (SKU) that includes all attributes associated with the item type that distinguish it from other item types and may include style, colour, size, specifications and is optionally set by the Manufacturer or Brand. For clothing it may include any identifying factors for example, product type or material (e.g., trouser, top, button-down, long sleeve, short sleeve, sleeveless, skinny bottom, low rise bottom, distressed, cotton, denim, wool, etc.).

In some embodiments, the SKU is a unique identifier for an individual product. In such embodiments, individual products can be tracked through its complete lifecycle.

In some embodiments, the methods and system are configured to include a complete inventory of all products available and optionally sold by a specific manufacturer or brand. Optionally, the complete inventory is only accessible to the manufacturer or brand. In some embodiments, the complete inventory optionally includes details regarding selling boutique/reseller, product SKU, seasons, time period the product sat in a specific boutique’s /reseller’s inventory, if the product was transferred between boutiques/resellers, when the product sold, suggested manufacture’s retail price, the price at which the product was sold, to whom the product was sold (Brand-to- boutique, boutique-to-boutique, boutique-to-consumer), where the product was shipped (customer of Boutique / Reseller, Boutique /Reseller), the end consumer of the product (customer of Reseller 1, customer of Reseller 2), type of sale (in-store or on-line) and if the product was returned and the reason the product was returned.

Optionally, the methods and system are configured to profile and predict the marketability of products within specific geographic regions and within certain seasons including calendar seasons or time of year.

In some embodiments, the combination of the collected data allows the system and method to optimize ‘curation and merchandising’ based on product movement, logistical lifespan and pricing. Optionally, the data can be analyzed internally in order to provide merchandising advisory to Manufacturer/Brand and Boutique/Reseller. Accordingly, in some embodiments, the system and method are configured to recommend products to Boutiques/Resellers, for example, the purchasing of products or (types of products).

The system and method are configured to provide recommendations to Manufacturers/Brands allowing for more efficient and optimal production, for example, information relating to the manufacturing of products (or types of products).

Optionally the system and method provide Boutiques/Resellers merchandise purchasing recommendations based on past data and reduce loss of profit margins through markdowns and logistical/warehousing lifespan.

In some embodiments, the methods and systems of the invention facilitate the development of a community, including on-line community of independent brick-and-mortar Boutiques/Resellers that provides for store-to-store transfer of inventory. Development of such a community can be advantageous when obtaining inventory from the regular supply chain is disrupted, product supply is limited or there are regionally disruptions in market. Optionally, the method and system is configured to decrease logistical time and cost, which increases profit margins, allows for quicker delivery (higher customer satisfaction) and reduces risk of logistical complications leading to loss or damage. It also allows for a more vast and varied supply of logistical services, whereby products are gee-located more regionally, creating the ability for community couriers (bikes, scooters, etc.) and even the boutique owners to deliver the products.

The methods and systems of the invention are optionally further configured to identify and track a product throughout its entire lifecycle, whether the product originates from the Manufacturer/Brand or from another Boutique/Reseller and optionally provide lifecycle information back to the Manufacturer/Brand. In some embodiments, where products retain value and there is a significant resale market, the methods and systems provide a system and method for tracking product post sale and a method to facilitate sale of used product back to the Manufacturer/Brand either directly or via a Boutique/Reseller and subsequent sale of the used product.

Boutique/Reseller to Boutique/Reseller product transfer can be driven by a customer request or by an individual store offering product for transfer. In some embodiments, a Boutique/ Reseller or Manufacturer/Brand may request transfer between Boutiques/Resellers.

Optionally, the method and system provide pre-built, identical navigation/customer experience, such that the consumer experiences an online-mall interface.

Customer driven requests are initiated when a potential customer accesses the online store front. Optionally, brick-and-mortar boutique/resellers can drive customers to the on-line store front by sending emails, instant or text messages to existing customers that include the necessary link to that Resellers′ on-line boutique reseller front. Such communications to existing customers may be provided at intervals and may highlight products in a customer specific manner, for example, highlighted products may be based on past purchases.

Optionally, a customer accesses the on-line store front of their preferred, “home”, brick-and- mortar boutique/reseller by means known in the art including but not limited to by secure login. Alternatively, the method and system display closest located Boutiques/Resellers, optionally in a specific category.

A customer views the available products via the on-line store front of their preferred, “home”, brick-and-mortar boutique/reseller. The available products are the products available from the pooled inventory. Optionally, individual products available from the pooled inventory are not distinguished based on the inventory they are physically part of. Pooled inventory is optionally updated upon sale or return of a product. In some embodiments, when a customer views a listing of products on the on-line store front, the customer does not see a difference in the product listings and therefore the product viewing and purchasing experience is seamless. Moreover, the virtual pooling or consolidation of the inventory allows the customer to deal only with a trusted source, namely the home brick-and-mortar boutique/reseller and the virtual representation thereof. In some embodiments, the home brick-and-mortar boutique/reseller will be the only contact with the customer including if products need to be returned.

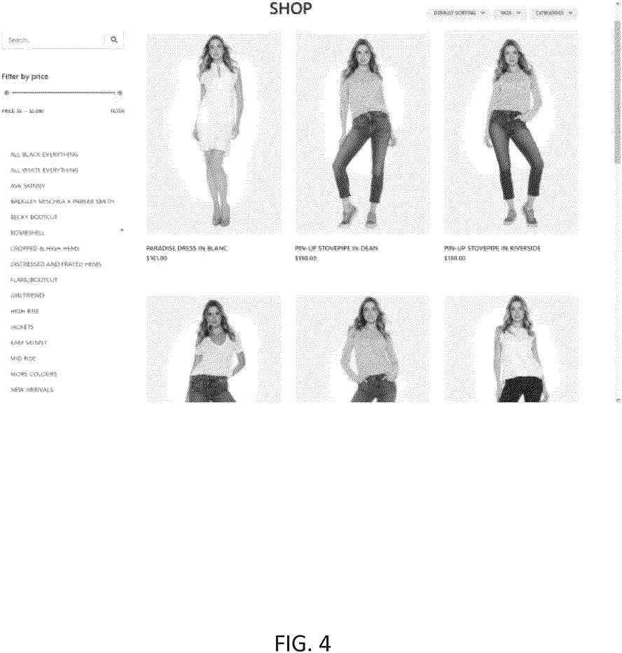

In some embodiments, products in the inventory of the home brick-and-mortar boutique/reseller are prioritized in the products presented to the customer either on a home page or in listed search results. For example, if a customer searches for jeans from the home store’s on-line store front, the jeans listed at the top of the search results will be jeans available from the home store’s inventory. Jeans available from the inventory of other stores in the pooled inventory will be deprioritized. Referring to FIG. 4, the homepage of the home on-line store front may show a selection of best-selling products or products specifically curated based on the specific customers purchasing history. The listed products include products available from the home stores inventory and inventory from other stores. In the illustrated example, the home boutique carries only two products, the Paradise dress in Blanc and the Pin-Up Stovepipe in Dean. All the other products shown are available from the pooled inventory.

In some embodiments, the homepage may show products based on length of time in inventory, optionally with new arrivals prioritized.

In some embodiments, the priority of listed products is tiered, wherein products available from stores that are geographically positioned to quickly physically transfer the purchased product to the home brick-and-mortar boutique/reseller are listed directly after products available from the home store. In some embodiments, products available from stores that the home store has successfully, previously transferred product from is prioritized over product from stores that the home store has not previously transferred product from. Optionally, in some embodiments, the method and system may be configured to exclude one or more stores from the pooled inventory shown. Exclusion from the pooled inventory may be a result of the excluded stores failure to satisfactorily complete a transfer of product.

Products transferred to the home store may be shipped by the home store to the customer, delivered by the home store to the customer or picked up by the customer at the store thereby maintaining the home store customer relationship. In certain embodiments, a product may be listed as being for personal delivery or pick up only. Such products are generally products requiring fitting, set up or adjustment. Returns of products is optionally handled exclusively by the home store allowing for inspection of the returned product. The home store approves or rejects products for return. In some embodiments, the terms and conditions are set by system, home boutique/reseller approves, rejects.

In some embodiments, the methods and systems of the invention may be used to transfer inventory to a home brick-and-mortar boutique/reseller in preparation for a scheduled, personalized shopping experience for a specific customer either at the brick-and-mortar boutique/reseller or at the customer’s home. In such embodiments, the customer selects a plurality of products that they wish to consider from the on-line store, any product not available for the home store’s inventory can be transferred from another store in the stores that contribute to the pooled inventory.

The methods and system of the invention incentivize the transfer of inventory between independent brick-and-mortar boutique/resellers by allowing an individual store to offer for sale an inventory that is larger than they would normally have. The methods and systems of the invention facilitate the movement of product out of inventory by in effect providing access to a larger market or customer base through the combined customer base of all other boutique/resellers on the system.

In some embodiments, the methods and systems provide a store transferring the product a commission or fee or a profit margin to transfer the product. Optionally, the commission is based on a percentage of the gross profit of the retailer if the product was sold at the manufacturer’s suggested retail price. The method and system are optionally configured to reimburse the price the transferring store paid for the product plus optionally any shipping and handling charges and any commission owed.

In some embodiments, the methods and systems provide a fee or commission to the market place. The fee may be per transfer or transaction, per successful transfer or transaction, monthly or annual fee or combination thereof.

The flowcharts and block diagrams in the attached figures illustrate the architecture, functionality, and operation of possible implementations of systems, methods, and computer program products according to various embodiments of the present disclosure. In this regard, each block in the flowcharts or block diagram may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowcharts and/or block diagram block or blocks.

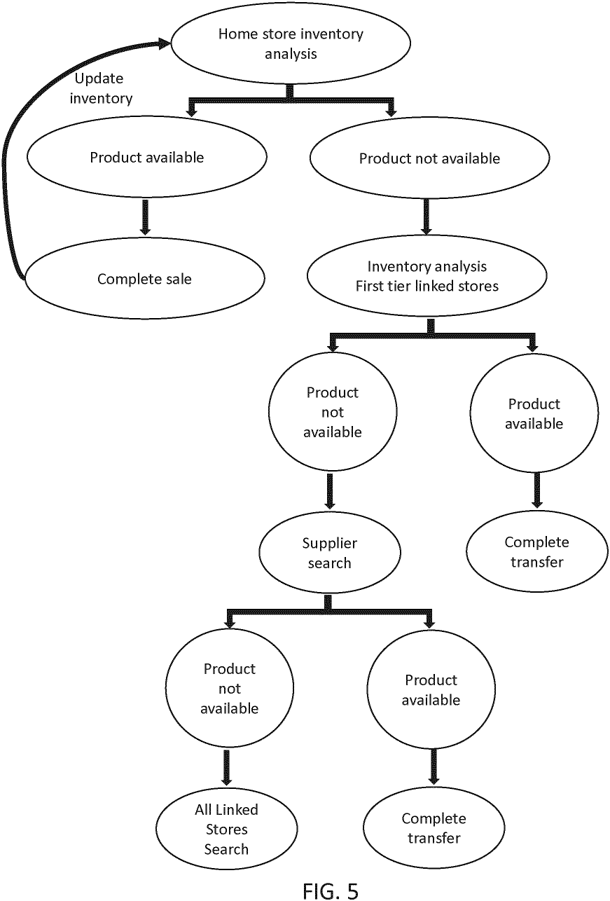

FIG. 5 illustrates a tiered inventory analysis in one embodiment of the present invention. After a customer orders a product from the on-line store front of the consumer’s home brick-and-mortar boutique/reseller, the method automatically searches a database that includes inventory data including information found in the SKU from the home brick-and-mortar boutique/reseller for the product. If the product is located within the inventory of the home brick-and-mortar boutique/reseller, the sales transaction is completed and optionally, the home brick-and-mortar boutique/reseller inventory is updated and global inventory is updated. If the specific product is not available from the home brick-and-mortar boutique/reseller inventory, the method and system search the inventory of first tiered linked stores for the product. First tiered linked stores include other brick-and-mortar boutique/resellers that are geographically positioned to quickly physically transfer the product to the home brick-and-mortar boutique/reseller and may include the stores that are physically closest to the home stores and/or stores proximal to major transport or courier routes to the geographical location of the home brick-and-mortar boutique/reseller. The first tier of stores search may include two stores, three stores, four stores, etc.

If the product is located in one first tier store, a request to transfer that product is sent to the store. The first-tier store must either confirm that they will transfer the product and update the system when the product is shipped to the home store or reject the transfer. In some embodiments, the transferring stores inventory is automatically updated. The method and system may be further configured to re-engage the method and system if the transferring store, after acceptance of the transfer is unable to complete the transfer, for example, if the product in their inventory is damaged and/or if the receiving store deems the product unsatisfactory.

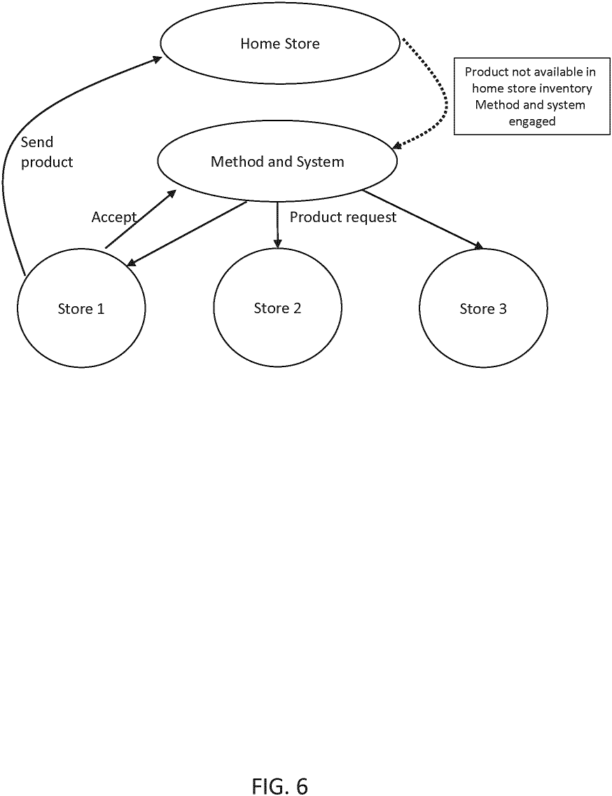

Referring to FIG. 6, if the product is located in two or more stores, the two or more other stores are sent a request for confirmation of product transfer. Upon receipt the request for confirmation of product available for transfer, each of the other stores has a set period of time to confirm product transfer. If a store confirms that they are able to transfer the product, the other stores are notified that the transfer has been accepted. If after acceptance, the store determines they are unable to complete the transfer, the request for product transfer may be re-sent to the other stores and/or the method and system are re-engaged.

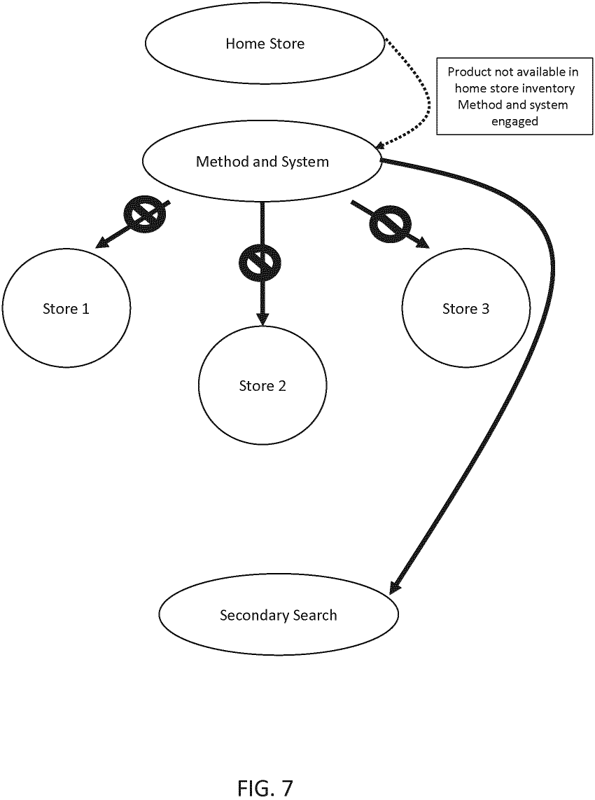

Referring to FIG. 7, if no first-tier stores are able to complete the transfer, the request is sent to a request for the product is sent to the product supplier, optionally who is the producer of the products or brand. If the product is out of stock, at the product supplier, a request is sent to all remaining stores that participate in the pooled inventory. In other embodiments, a request can be sent to an alternative subset of stores. Optionally, this step is repeated until the product is located or all stores have been sent a request. If no stores are available to transfer the product, the customer is notified that the home store is unable to fulfill the order.

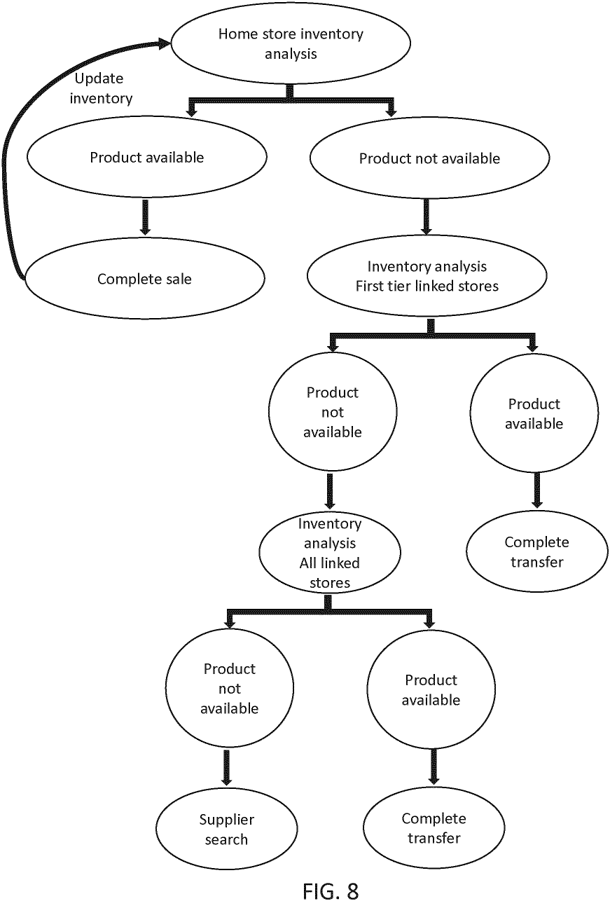

Referring to FIG. 8, alternatively, if no first-tier stores are able to complete the transfer, the request is sent to an alternative set of stores or all remaining stores that participate in the pooled inventory. If no stores are available to transfer the product, the product, if available, is sent from the product supplier, optional who is the producer of the products. If the product is not available from the supplier, the customer is notified that the home store is unable to fulfill the order.

Optionally, the method and system monitor the percent acceptance for each boutique/reseller participating in the method and system. In some embodiments, if acceptance rates fall below a pre-determined level, a notification, optionally automatically, is sent to the store indicating that their rate of acceptance is below acceptable levels and that the stores participation in the method and system may be suspended.

Optionally, the method and system provide for rating and/or review of the transferring and/or receiving stores. In some embodiments, the rating and/or review is multi-factorial.

In some embodiments, home stores with excess inventory or inventory that is not selling may transfer the inventory to one or more other brick-and-mortar boutique/resellers. In some embodiments, the method and system may be configured to recommend or request transfer of inventory based on regional sales data.

A brick-and-mortar boutique/reseller, when joining the on-line boutique community, set up a secure account or profile and uploads store inventory information to the home inventory database. Optionally, the method and system may be integrated with other inventory management systems. In some embodiments, the database is automatically updated when there is changes in inventory. In other embodiments, changes in inventory are manually entered.

In some embodiments, the home inventory database is a separate and independent database which the method and system of the invention accesses. In alternative embodiments, the inventory database includes inventory data from a plurality of independent brick-and-mortar boutique/resellers including the inventory data from the home brick-and-mortar boutique/reseller. If such a database is used, the initial product search is limited to the inventory of the home brick-and-mortar boutique/reseller.

Each product entry in the database includes one or more of the following fields: product identifier field, SKU, product name field, brand field, product description fields, product image fields, store information and keyword fields to facilitate a keyword product search. One or more fields in the product entry may be self-populating after entry of the product identifier or product name. Each product entry may include metadata identifying its current location including brick- and-mortar boutique/reseller and geographical location. Optionally, each brick-and-mortar boutique/reseller is assigned a unique identification number.

In embodiments where the product supplier or brand is part of the on-line community, the systems and methods may be used to order inventory directly from the product supplier.

To on board a new brick-and-mortar boutique/reseller, the new brick-and-mortar boutique/reseller accesses the sign-up page. Optionally, brick-and-mortar boutique/resellers are invited to join the on-line community. In such embodiments, the store may receive an email invite with a link to the sign-up page. The brick-and-mortar boutique/reseller sets up a secure account by methods known in the art. Brick-and-mortar boutique/reseller account set up may optionally include providing store branding material and information including logos and trademarks. The brick-and-mortar boutique/reseller logs on to the secure account and uploads inventory information. From the uploaded information the method and system populate a store front. Optionally, various store front templates are provided.

Optionally, the store uploads customer information including customer contact information and optionally purchasing history and sets a customer communication schedule such that automatic communications to customers can be sent.

The methods of the invention can be implemented by a computer implemented inventory management system that includes or interacts with a variety of modules. Modules of the system include an inventory management module configured to receive inventory data from a plurality of brick-and-mortar boutique/resellers and optionally one or more brands. In some embodiments, the inventory management module is operatively associated with a user interface that allows a user to input or adjust inventory information. The inventory information can be inputted manually or uploaded from one or more inventory management systems.

The inventory management module includes or is operatively associated with at least one inventory database detailing the physical inventories of the brick-and-mortar boutique/resellers in the on-line community. Each inventory database includes a plurality of searchable product entries. These inventory databases are regularly updated to reflect the current pooled inventory available, and in some embodiments, the updates with respect to the sale of the product and lifecycle information.

Optionally, the inventory management module includes or is associated with a reporting module configured to provide detailed reports regarding the status of the inventory and sales. Optionally, the reports may include a forecasting or projection of sale trends based on past sales, region and season, amongst other factors known in the art.

The inventory management system also includes a store management module configured to receive store information for each boutique/reseller in the on-line community. The store management module includes at least one store database. Each store database includes a plurality of searchable store entries that include one or more of store name, store logo, store location, contact information and rating. The rating is indicative of compliance with requirements for being part of the on-line community.

The inventory management system also includes an inventory management application module configured to facilitate transfer of inventory from one brick-and-mortar boutique/reseller to another brick-and-mortar boutique/reseller. To transfer product, the inventory management application module’s one or more processors execute one or more programs stored on associated memory. The one or more programs comprise instructions for searching at least one inventory database for a selected product; identifying at least one physical inventory containing the product; determining if the product needs to be transferred to a different physical inventory; and initiating the transfer the product, if necessary.

The inventory management system may further include or be operatively associated with various other modules including financial transaction modules and communication modules.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random-access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

The systems and methods may further provide boutique to boutique chat functions.

The system and methods may further be configured to facilitate returns.

Although the invention has been described with reference to certain specific embodiments, various modifications thereof will be apparent to those skilled in the art without departing from the spirit and scope of the invention. All such modifications as would be apparent to one skilled in the art are intended to be included within the scope of the following claims.

1. An on-line method of selling a product available at a brick-and-mortar boutique/reseller, the method comprising:
storing, in a database, inventory data from a plurality of independent brick-and-mortar boutique/resellers, wherein the inventory data includes a plurality of product descriptions for products available for sale from the physical inventory of each boutiques/resellers in the plurality of brick-and-mortar boutique/resellers, wherein each product description is tagged with metadata describing the product, physical brick-and-mortar boutique/reseller location of the product and geographical location; and wherein the plurality of brick-and-mortar boutique/resellers comprises a consumer’s home brick-and-mortar boutique/reseller and a plurality of other brick- and-mortar boutique/resellers;
providing an independent, on-line store front for each boutique/reseller in the plurality of brick-and-mortar boutique/resellers; wherein each on-line store front provides a consumer interface for selecting a product for purchase from the plurality of product descriptions and wherein the on-line store front presented to a consumer is the on- line store front of the consumer’s home brick-and-mortar boutique/reseller;
locating product selected by the consumer by searching the database for the product in the physical inventory of the home brick-and-mortar boutique/reseller, if the product is not available in the physical inventory of the home brick-and-mortar boutique/reseller, locating the product in the physical inventory of a other brick-and- mortar boutique/reseller;
transferring the product, if available, from the other brick-and-mortar boutique/reseller to the home brick-and-mortar boutique/reseller; and
completing the sale of the product to the consumer.

2. The method of claim 1, wherein a plurality of independent, on-line store fronts is on a splash page or landing page.

3. The method of claim 1 or 2, wherein a link to a specific independent front is sent to an existing customer of the corresponding brick-and-mortar boutique/reseller.

4. The method of any one of claims 1 to 3, wherein the inventory data is automatically updated when there is a change in the physical inventory of a store in the plurality of brick-and-mortar boutique/resellers.

5. The method of any one of claims 1 to 4, wherein the inventory data includes a plurality of product descriptions for products available for sale from a product supplier.

6. The method of claim 5, wherein the product supplier produces the products.

7. The method of any one of claims 1 to 6, wherein each on-line store front is configured to highlight products available from the physical inventory of the brick-and-mortar boutique/reseller the on-line store represents.

8. The method of any one of claims 1 to 7, further comprising providing a commission to the other brick-and-mortar boutique/reseller that transferred product to the home brick- and-mortar boutique/reseller.

9. The method of any one of claims 1 to 8, wherein each independent, on-line store front is based on a template.

10. The method of any one of claims 1 to 9, wherein locating the product in the physical inventory of the other brick-and-mortar boutique/reseller comprises identifying one or more stores having the product in their physical inventory; sending a request for transfer to at least one identified store.

11. The method of claim 10, wherein a request for transfer is sent to all stores having the product within a geographical distance of the requesting store.

12. The method of claim 5 or 6, wherein if the product is not in the physical inventory of an other brick-and-mortar boutique/reseller, transferring the product from the product supplier.

13. The method of any one of claims 1 to 12, wherein the method further comprises identifying sales trends.

14. The method of claim 13, wherein the identifying sales trends comprises identifying products that sell preferentially based on location.

15. The method of claim 14, comprises offering for transfer products that are more likely to sell at a different store without a prior purchase.

16. The method of claim 15, comprising sending an offer for transfer for a product to a store it is more likely to sell at.

17. The method of any one of claims 1 to 16, wherein a consumer’s home brick-and-mortar boutique/reseller is selected by the consumer and/or based on physical location of the consumer.

18. A computer implemented inventory management system comprising:
an inventory management module configured to receive inventory data from a plurality of brick-and-mortar boutique/resellers, said inventory management module comprising at least one inventory database detailing the physical inventories of the brick-and-mortar boutique/resellers;
a store management module configured to receive store information, said store management module comprising at least one store database;
an inventory management application module configured to facilitate transfer of inventory from one brick-and-mortar boutique/reseller to another brick-and-mortar boutique/reseller;
one or more processors; and
memory storing one or more programs to be executed by the one or more processors, the one or more programs comprising instructions for:
searching at least one inventory database for a selected product; identifying at least one physical inventory containing the product;
determining if the product needs to be transferred to a different physical inventory; and initiating the transfer the product, if necessary.

19. A computer implemented method of tracking a product available at a plurality of brick-and-mortar boutiques or resellers through the products life cycle, the method comprising:
storing, in a database, inventory data from a plurality of independent brick-and-mortar boutique/resellers, wherein the inventory data includes a plurality of product descriptions for products available for sale from the physical inventory of each boutique/reseller in the plurality of brick-and-mortar boutique/resellers, wherein each product description is tagged with metadata describing the product, physical brick- and-mortar boutique/reseller location of the product and geographical location; and
updating the inventory data is automatically updated when there is a change in the physical inventory of a store in the plurality of brick-and-mortar boutique/resellers.

20. The method of claim 19, wherein the inventory data includes a plurality of product descriptions for products available for sale from a product supplier.

21. A computer implemented inventory management system comprising:
an inventory management module configured to receive inventory data from a plurality of brick-and-mortar boutique/resellers, said inventory management module comprising at least one inventory database detailing the physical inventories of the brick-and-mortar boutique/resellers;
a store management module configured to receive store information, said store management module comprising at least one store database;
an inventory management application module configured to track inventory; one or more processors; and
memory storing one or more programs to be executed by the one or more processors, the one or more programs comprising instructions for:
receiving sales and/or product return information from one or more brick-and-mortar boutique/resellers; and
updating the inventory database.
